(19) United States
(12) Patent Application Publication
(10) Pub. No.: US 2022/0354083 A1
(43) Pub. Date: Nov. 10, 2022

(54) A SYSTEM AND METHOD FOR CONTROLLING AND MONITORING VENTILATION SYSTEMS FOR CLOSED ANIMAL STRUCTURES

(71) Applicant: MGH AGRICULTURAL TECHNOLOGIES LTD., Givat Haim Eihud, N. D. Hefer (IL)

(72) Inventors: Shlomo BAR-NES, Avigdor (IL); Arie HAHAM, Gedera (IL); Ofer RONEN, Beit Herut (IL); Asaf MACABI, Haruzim (IL)

(21) Appl. No.: 17/636,927

(22) PCT Filed: Aug. 19, 2020
(86) PCT No.: PCT/IB2020/057802

§ 371 Date: Feb. 21, 2022

Related U.S. Application Data
(60) Provisional application No. 62/888,566, filed on Aug. 19, 2019.

(51) Int. Cl. A01K 1/00

(52) U.S. Cl. CPC A01K 1/0052; A01K 1/0064

(57) ABSTRACT

A ventilation system for a housing structure with a plurality of air vents including: vent control modules configured to control and actuate opening and closing of at least one air vent of the plurality of air vents; an electro-mechanical drive unit mechanically coupled to each of the plurality of vent control modules and providing mechanical power thereto, the drive unit including a motor and a drive shaft, the drive shaft being disposed parallel to the axis of the air vents; a control unit, in communication with the drive unit and the plurality of vent control modules, configured to control the drive unit and individually control each of the vent control modules; the vent control modules use the mechanical power of the drive unit to individually effect the opening and closing of each respective vent of the plurality of air vents.

### FIELD OF THE INVENTION

The present invention relates to a ventilation management system, and more specifically, an air vent management system for a poultry house.

### BACKGROUND OF THE INVENTION

Poultry farming has been in existence for hundreds and even thousands of years. Industrialized poultry farming began to develop during the 20th century, leading to the raising of massive quantities of domesticated poultry in large, industrialized poultry houses.

Raising poultry in a massive, industrialized setting requires great attention to the finest of details, if the farmers wish to maintain quality and high output. Smart command and control systems and advanced technologies continue to develop, thus increasing the ability of growers to control the majority of the conditions in the poultry houses.

The idea/concept and/or method and/or product/s presented here within provide a conceptual, original, and innovative technological solution that is very unique and practical. This solution can incorporate existing products and/or technologies and/or software and/or applications in use in the sector. The product and solution can be successfully integrated into the poultry framing industry, for the poultry house and chicken coop sector.

The idea and/or method and/or product/s are based upon an innovative and original idea that incorporates innovative technological capabilities and/or that offers an innovative integration of existing functions and/or technologies combined. The business world is constantly growing and a fast and direct line of communication has developed between technological companies and/or manufacturers and/or marketing companies. Customers in different countries around the world are connected online at almost every moment of the day and night via the internet and/or other media software. The growth of consumer use has become even more significant in this era of global industry and marketing. It therefore follows that upon presenting the farming and/or industrial and/or potential marketing sectors with an original, practical and attractive product that incorporates a technological product that is in great demand and/or need, the potential for a successful business initiative will develop in this sector.

Conceptual simplicity, combined with products and/or existing and advanced technologies will incorporate the capabilities of existing and new components and/or technologies, thereby bringing this proposal to fruition to provide high quality technological and commercial performance.

### SUMMARY OF THE INVENTION

Poultry farming in general, and more specifically, within industrialized buildings, demands extra care and attention to major issues so as to succeed in raising high quality/industrialized poultry with professional and commercial results. It is vital to maintain sanitation, hygiene, health, nutrition, climate control and other parameters.

Industrialized poultry farming significantly increases the sensitivity and exposure of the poultry to health problems, sanitation issues, infectious diseases and many other obstacles. Professional farming and growing, controlled via immediate and online access to any problem that may arise among the poultry/within the coop, and combined with advanced technologies will dramatically improve and promote performance and quality. The innovative patent presented here was designed to provide a method and/or innovative, original system with professional and innovative capabilities to ensure the highest quality results available in poultry farming.

According to the present invention there is provided a ventilation system for a housing structure with a plurality of air vents disposed sequentially along an axis running along a side of the structure, the system including: a plurality of vent control modules, each of the vent control modules configured to control and actuate opening and closing of at least one air vent of the plurality of air vents; a drive unit, the drive unit being an electro-mechanical drive unit mechanically coupled to each of the plurality of vent control modules and providing mechanical power thereto, the drive unit including a motor and a drive shaft, the drive shaft being disposed parallel to the axis of the air vents; a control unit, in communication with the drive unit and the plurality of vent control modules, the control unit configured to control the drive unit and individually control each of the vent control modules; wherein the vent control modules use the mechanical power of the drive unit to individually effect the opening and closing of each respective vent of the plurality of air vents.

According to further features in preferred embodiments of the invention described below each of the vent control modules additionally controls one or more vents of the plurality of air vents. According to still further features in the described preferred embodiments the system further includes at least one temperature sensor. According to further features the system further includes at least one pressure sensor.

According to further features the motor is a unidirectional motor. According to further features the motor is a bi-directional motor. According to further features each of the vent control modules includes an actuation mechanism, the actuation mechanism adapted to be coupled to the drive shaft so as to harness the mechanical power. According to further features the mechanical power is expressed as rotational movement. According to further features the mechanical power is expressed as linear movement.

According to another embodiment there is provided a method for individually controlling air vents in a livestock house, the method including the steps of: receiving, at a control unit, initial data regarding the livestock in the house, the initial data being the inputted via a user interface; receiving, at the control unit, position data regarding each of the air vents, the position data being received from vent control modules collocated with the air vents; receiving, at the control unit, sensor data from sensors; processing, by the control unit, the sensor data by comparing the sensor data to the initial data and determining an optimum position for each of the air vents; and sending instructions to a drive unit and the vent control modules operationally coupled to the drive unit to move each of the air vents to the determined optimum position. According to further features the position data is received by the vent control modules from microswitches attached to each of the air vents.

### BRIEF DESCRIPTION OF THE DRAWINGS

Various embodiments are herein described, by way of example only, with reference to the accompanying drawings, wherein:

FIG. 1 is a prior art ventilation system for a chicken house;

FIG. 2 is a partial view of one wall of a poultry house 10 with a row of air vents 12;

FIG. 2A is a magnified view of the designated area of FIG. 2;

FIG. 3 is a same general system as depicted in FIG. 2, with the exception of the drive shaft providing linear movement;

FIG. 3A is a magnified view of the designated area of FIG. 3;

FIG. 4 is a block diagram of the instant system as implemented in a poultry house;

FIG. 5 is a flow diagram of the instant system process 500.

### DESCRIPTION OF THE PREFERRED EMBODIMENTS

The principles and operation of air vent control system according to the present invention may be better understood with reference to the drawings and the accompanying description.

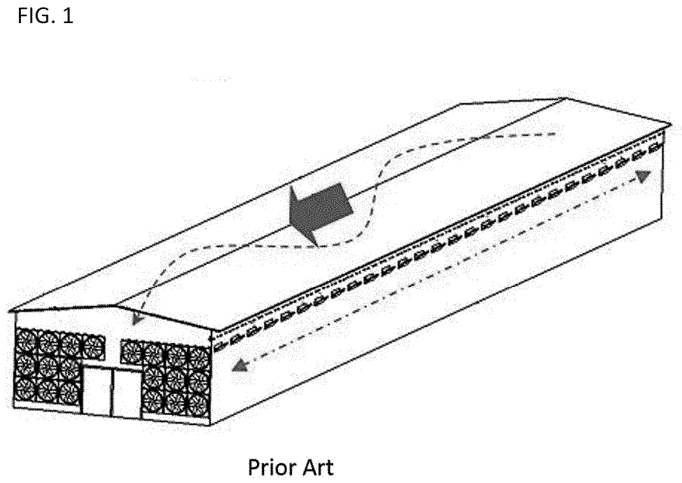

FIG. 1 illustrates a prior art ventilation system for a chicken house. All the air vents are controlled collectively by a linear or axial actuation system. The actuation system either opens or closes all the vents at the same time.

The instant innovative system enables the poultry house manager executive control over the poultry house climate. By taking into consideration the age of the birds in the house, external temperature, internal temperature and/or pressure, the vent-on-demand system optimizes the air flow, moisture and air pressure in the house, making the poultry house to a controlled environment. The system creates an equalized environment by increasing the amount fresh air that flows inside and optimizing the air flow, to make it more efficient. In some configurations, the system also increases the amount of hot and/or moist air that flow out.

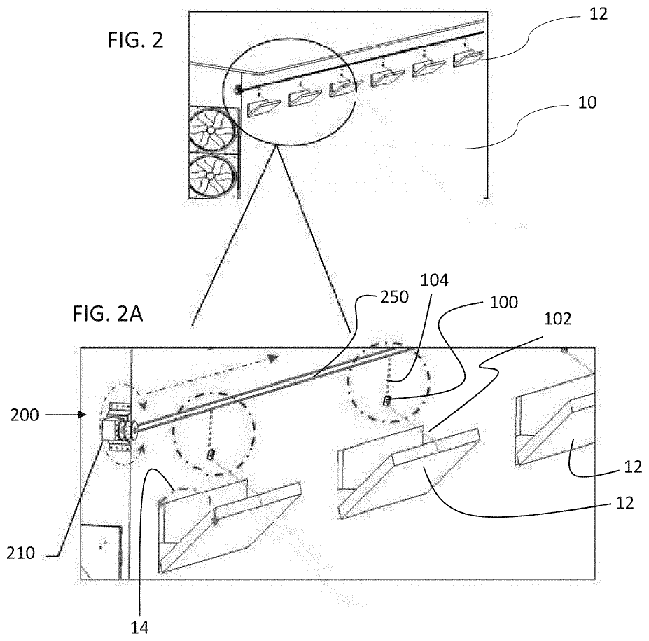

FIG. 2 illustrates a partial view of one wall of a poultry house 10 with a row of air vents 12. Each air vent has a vent control module 100. The vent control module 100 is configured to control opening and closing of the vent with which it is collocated. Each row of air vents (usually two rows, one on each side of the long, rectangular poultry house) is driven by a single drive unit 200. FIG. 2A is a magnified view of the designated area of FIG. 2.

The drive unit 200 is made up of a motor 210 and a shaft 250. The motor is located on one end of the row of air vent. The shaft runs from the motor on the one end of the air vents to the last air vent on the other end of the row of air vents. All the air vents open and close by turning about a common axis. (The exemplary opening and closing directions are indicated by arrow 14.) The shaft of the motor runs along an axis parallel to the vents' axis. Each of the vent control modules 100 is mechanically coupled to the shaft 250.

The drive unit 200 is an electro-mechanical drive unit which is mechanically coupled to each of the vent control modules 100 and provides mechanical power to these modules to open or close the vents 12.

Uniquely, owing to the action of the vent control modules, the mechanical power of the motor is used to control or actuate the vent movement on an individual basis. Said another way, the vent control modules use the mechanical power of the [single] drive unit to individually effect opening and closing of each respective vent of the plurality of air vents disposed along a wall of the poultry house 10.

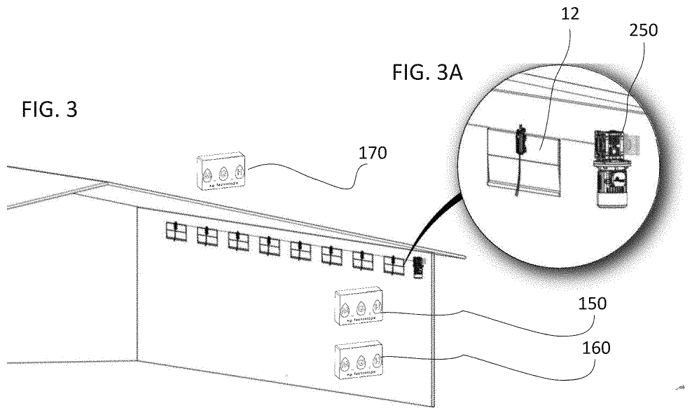

Another possible configuration is shown in FIG. 3. FIG. 3 depicts a same general system as depicted in FIG. 2, with the exception of the drive shaft providing linear movement as opposed to rotational movement (torque) or the former configuration. FIG. 3A is a magnified view of a portion of FIG. 3. Similar parts are referenced with the same numbers. Since the drive unit in both configurations includes the same basic components: a motor and a drive shaft, all the components are similarly referenced. The description herein applies equally to both configurations except for the sections that discuss the direction of movement of the drive shaft or the type of motor. In a similar fashion, components mentioned in conjunction with one configuration are to be understood as applying equally to the other configuration, as if depicted in the figures and set forth fully herein.

In the configuration providing linear movement, the motor can be a rotational motor or a linear motor. The rotational motor converts the rotational movement into linear movement as is well known in the art. All linear actuators are considered to be included within the scope of the invention. The linear movement in a first direction (e.g. away from motor) is used by the individual vent control modules to open the respective air vents whereas movement in the opposite direction is harnessed by the individual vent control modules to close the respective air vents.

A control unit 300, not shown in either FIG. 2 or 3, provides the commands to both the drive unit and the vent control modules. Various sensors inside and outside the poultry house provide specific information, such as temperature and pressure. Other sensors may also be employed, such as humidity sensors. FIG. 3 depicts an internal temperature sensor 150. Even though there is only a single unit depicted in the figure, it is made clear that in some cases there is a single sensor but, in most cases, there are numerous sensors placed at intervals throughout the house. Each of the air vents can be opened or closed individually without regard to the status/position of the neighboring air vent. Accordingly, there can be as many sensors as there are air vents.

FIG. 3 further depicts an air pressure sensor 160. Again, the single pressure sensor is, or can be, merely representative of a plurality of pressure sensors. Here too, there may be multiple air pressure sensors, even as many pressure sensors as there are air vents. A third sensor, outdoor temperature sensor 170, is located outside the poultry house. All the sensors are in wired or wireless communication with the control unit.

The above notwithstanding, a most cost-effective implementation of the system will likely divide the house into a grid of sections or group of otherwise designated sections. Each section will likely have at least one temperature sensor. In some embodiments, the sections will each have at least one air pressure sensor. In such a scenario, the it is likely that all the vents in a given section will be closed, opened or partially opened to the same degree.

With the above scenario in mind, in a variation of the instant system, each vent control module controls two or more air vents which are collocated in a predefined subsection of the row of vents. Such a variation will have a similarly precise ability to regulate temperature and/or pressure in the house, but at a lower overall cost to the system.

In all embodiments and variations, the temperature sensor or sensors are in communication, with the control unit 300. In embodiments with air pressure sensors, the pressure sensors are also in communication with the control unit. The aforementioned sensors may be in direct communication with the control unit or in indirect communication with the control unit. An example of the latter configuration entails the sensors providing sensor data to a central temperature and/or pressure management unit, which may or may not be collocated with the control unit. The management unit is in communication with the control unit. The management unit, in such an embodiment, may provide sensor data to the control unit. Alternatively, the management unit can decide (e.g. the computer logic of the management unit in conjunction with predefined parameters, or the like) which air vents need to be opened or closed (or to what degree to open the vents) and send that information to the control unit 300. Control unit 300 will instruct the motor and vent control modules how to act.

The air vents 12 may open in any manner and either inwardly (into the house) or outwardly. One exemplary mechanism is a rack and gear arrangement whereby the air vent has an arcuate shaped rack interlocked with a gear. Rotation of the gear in a first direction opens the vent and rotation of the gear in the opposite direction closes the vent. Another exemplary opening control mechanism is chain drain. Other examples include belt and rope drives. Essentially, any applicable drive or actuator can be employed. In FIG. 2, the depicted opening control mechanism is a chain drive with a chain 102 coupled to the vent control module 100 which in turn is coupled to the drive shaft 250 via a coupling member 104. Coupling member 104 provides or transfers the rotational movement (torque) of the drive shaft to the vent control module 100. Based on instructions received from the control unit, vent control module either transmits the mechanical power of the rotational movement of the shaft to chain 102 or not. In some cases, as discussed hereafter, the vent control module can even invert the direction of rotation (e.g. to close a vent instead of opening it) when the motor is a unidirectional motor.

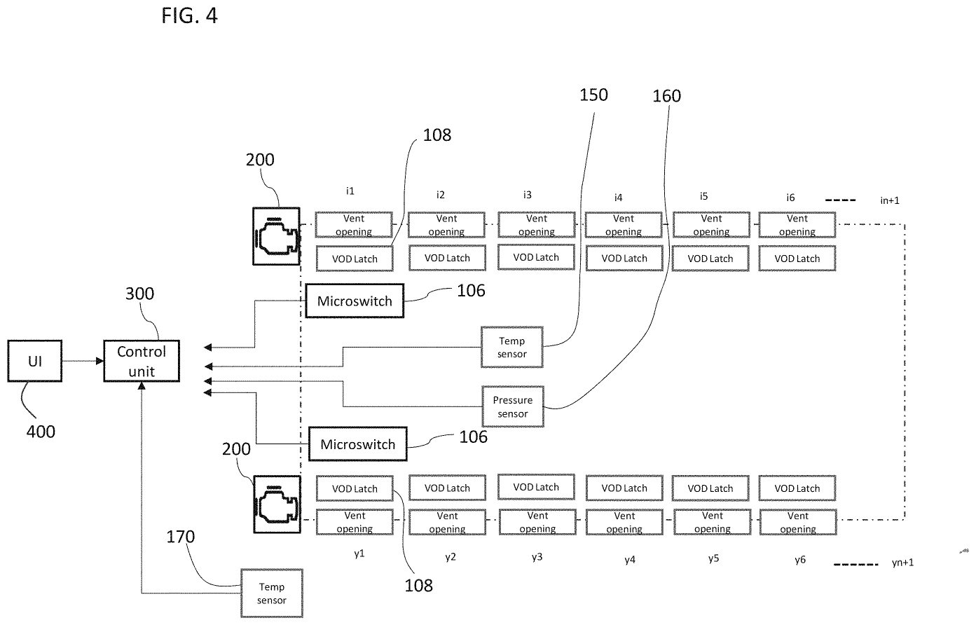

FIG. 4 is a block diagram of the instant system as implemented in a poultry house. The system is accessed by a user via a user interface (UI) 400. The user interface usually includes peripherals such as a keyboard and mouse for inputting information. In addition, the UI usually has a display screen for displaying the data to the user. It is commonplace today to integrate the input devices and display into a touchscreen panel that functions to receive input as well as display data. The UI may be any type of user interface.

A control unit 300 is the brain of the system, as detailed above. The control unit includes the processors and other components necessary for receiving sensor data, decision making and sending of instructions. These components are well known in the art and include at least communications modules (for wired and/or wireless communication), power connectors, internal computer memory, computer storage, CPUs etc. Software installed on the computing devices contain code and logic for performing all of the activities described herein.

Each wall has a dedicated drive unit 200 that provides mechanical power for the vents along that wall. In some embodiments, each vent has a microswitch 106 which provides the control unit and/or the vent control module information regarding the position of the individual vent. In embodiments, each vent has a vent-on-demand (VOD) electro-mechanical latch 108. According to some configurations, there can be up to 256 latches in one house. The system includes one or more indoor temperature sensor 150, pressure sensor 160 and outdoor temperature sensor 170. In the diagram, vents on one side of the house are labeled i1−in+1 and on the other wall y1−yn+1.

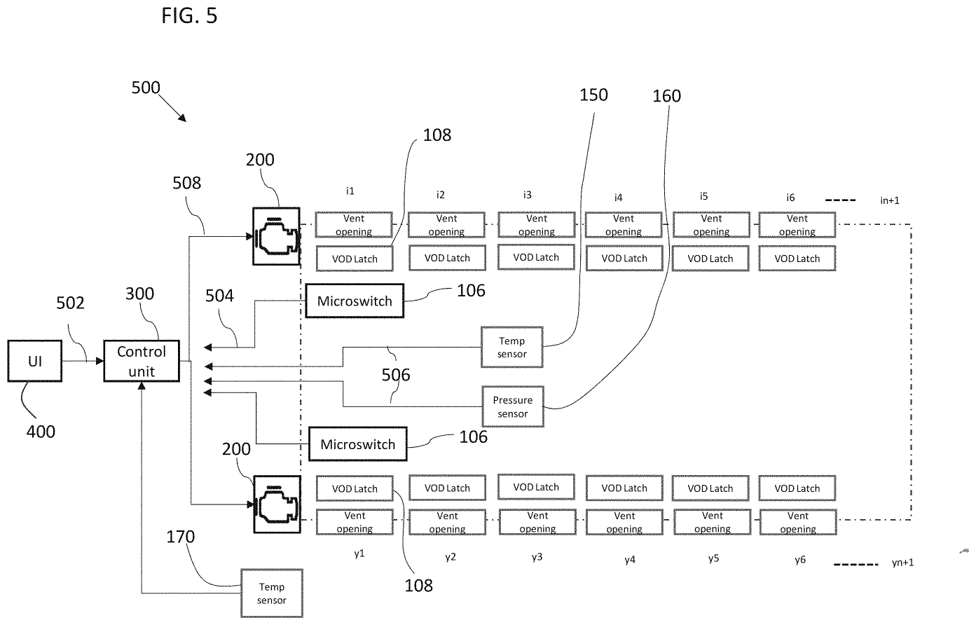

FIG. 5 is a flow diagram of the instant system process 500. The process includes various steps which may or may not be sequential. Some of the steps are repetitive such that various steps happen simultaneously. At step 502 a user enters initial input via the user interface 400 to the system control unit 300. For e.g. the age table, according to the relevant flock. All other initial or baseline information is also entered in this step. The user further inputs the desired temperature range. Vents are opened or closed based on the inputted (or predefined) temperature and in accordance to the sensor data received from, at least, the temperature sensor 150. In some embodiments, the user has a pre-taught (i.e. programmed) option to schedule a “domino mode”—whereby vents are opens sequentially, one after the other.

In step 504 the control unit receives position data and thereby verifies the position of each vent. The position data is received from the vent control modules or microswitches. In some embodiments that include microswitches, the control unit can query the microswitch of the vent directly.

In step 506 the sensors (e.g. indoor temperature sensor, pressure sensors, outdoor temperature sensor) transmit feedback (send sensor data) to the control unit (either directly or indirectly).

In step 508, control unit 300 processes the received data and cross checks sensor data with predefined parameters (e.g. the age table) and sends instructions to close or open or adjust the relevant air vents. The control unit determines an optimum position for each of the air vents; and sends instructions to the relevant drive unit and to each of the vent control modules operationally coupled to that drive unit to move each of the air vents to the determined optimum position.

Go back to step 504.

Example 1—a bi-directional motor

In this example, the motor 210 can either rotate the shaft 250 clockwise or anticlockwise, as is well known in the art. Exemplarily, there are 30 air vents arranged along a single axis on one wall of the house. The control unit 300, based on sensor data, ‘decides’ (or receives user input indicating) that some air vents (i6-i10) must be fully opened, some (i16-i20) partially opened and some (i21-i25), which are already open, must be closed. The air vents open, according to the instant example, with transferred clockwise rotational movement. The control unit sends a command to start the motor in a clockwise direction. The control unit sends commands to the vent control modules 100 that control opening of air vents i6-i10 and i16-i20 to mechanically couple to the drive shaft such that the rotational movement of the shaft is transferred to the actuation mechanism that controls opening and closing of the air vent. For example, the actuation mechanism is a rack and pinion arrangement. Clockwise rotational movement of the shaft is translated into clockwise movement of the pinion (gear), which, interlocking with the arcuate rack, opens the air vents.

Vent control modules for vent i16-i20 disengage the actuation mechanism(s) from the shaft after the vents are partially opened to the specified degree. E.g. after a predetermined number of rotations of the shaft or based on electrical feedback from a microswitch that indicates that the vent has been opened the predetermined amount. The actuation mechanisms of vent i6-i10 remain engaged with the shaft until the air vents are fully open, disengaging thereafter.

Control unit 300 then instructs the motor to reverse direction (e.g. reversing the electrical current), and now rotate in the anticlockwise direction. Vent control modules engage the actuation mechanisms of vents i21-i25 in order to close these vents. Once the vent control modules determine that the vents are closed (e.g. by monitoring number of rotations or receiving an indication from a micro switch etc.), the actuation mechanism disengages from the shaft and/or the motor shuts down.

Example 2—a unidirectional motor.

In another exemplary configuration, the motor only runs in one direction. Initially, the control unit instructs the motor to start running (if not already running). The control unit instructs vent control modules to open vents y5, y7 and y13 to a 45-degree angle off the vertical; open vents y1, y9 and y18 to a 15-degree angle; and close vents y20-y22. Since the motor shaft 250 only rotates in one direction, it is the vent control module that harnesses the rotational movement of the shaft in either the same direction—i.e. direct translation of the rotational movement of the shaft to the air vent—or the opposite direction.

The latter option is effected by the particular vent control module converting the movement in the first direction (e.g. clockwise) of the shaft into movement in a second direction (e.g. anticlockwise) by methods known in the art (e.g. interlocking gears where the first gear is rotated in the same direction as the shaft rotation and the second gear rotates in the opposite direction).

According to the instant exemplary configuration, different vents can move in different directions simultaneously, under the direction of the individual vent control modules. Another advantage is that the motor can run continuously, without regard to whether the vents need to be opened or closed (or moved at all). In fact, a motor from another system, such as a fan motor, could theoretically be harnessed to provide the rotational power to the shaft. The fan may be employed for a different function (e.g. controlling airflow within the structure). Yet another advantage of the instant configuration is that a unidirectional motor is simpler, cheaper and will have less wear-and-tear than a bi-directional motor that keep alternating direction.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A ventilation system for a housing structure with a plurality of air vents disposed sequentially along an axis running along a side of the structure, the system comprising:
a plurality of vent control modules, each of said vent control modules configured to control and actuate opening and closing of at least one air vent of the plurality of air vents;
a drive unit, said drive unit being an electro-mechanical drive unit mechanically coupled to each of said plurality of vent control modules and providing mechanical power thereto, said drive unit including a motor and a drive shaft, said drive shaft being disposed parallel to the axis of the air vents;
a control unit, in communication with said drive unit and said plurality of vent control modules, said control unit configured to control said drive unit and individually control each of said vent control modules;
wherein said vent control modules use said mechanical power of said drive unit to individually effect said opening and closing of each respective vent of the plurality of air vents.

2. The system of claim 1, wherein each of said vent control modules additionally controls one or more vents of the plurality of air vents.

3. The system of claim 1, further comprising at least one temperature sensor.

4. The system of claim 1, further comprising at least one pressure sensor.

5. The system of claim 1, wherein said motor is a unidirectional motor.

6. The system of claim 1, wherein said motor is a bi-directional motor.

7. The system of claim 1, wherein each of said vent control modules includes an actuation mechanism, said actuation mechanism adapted to be coupled to said drive shaft so as to harness said mechanical power.

8. The system of claim 7, wherein said mechanical power is expressed as rotational movement.

9. The system of claim 7, wherein said mechanical power is expressed as linear movement.

10. A method for individually controlling air vents in a livestock house, the method comprising the steps of:
receiving, at a control unit, initial data regarding the livestock in the house, said initial data being the inputted via a user interface;
receiving, at said control unit, position data regarding each of the air vents, said position data being received from vent control modules collocated with the air vents;
receiving, at said control unit, sensor data from sensors;
processing, by the control unit, said sensor data by comparing said sensor data to said initial data and determining an optimum position for each of the air vents; and
sending instructions to a drive unit and said vent control modules operationally coupled to said drive unit to move each of the air vents to said determined optimum position.

11. The method of claim 10, wherein said position data is received by said vent control modules from microswitches attached to each of the air vents.
